(19) United States
(12) Patent Application Publication
(10) Pub. No.: US 2014/0089845 A1
(43) Pub. Date: Mar. 27, 2014

(54) APPARATUS AND METHOD CAPABLE OF SWITCHING DISPLAYED PICTURES

(71) Applicants: HAI-SEN LIANG, Shenzhen (CN); CHIH-SAN CHIANG, New Taipei (TW); SHI-NING YANG, Shenzhen (CN); XIANG HE, Shenzhen (CN); HUA-DONG CHENG, Shenzhen (CN)

(72) Inventors: HAI-SEN LIANG, Shenzhen (CN); CHIH-SAN CHIANG, New Taipei (TW); SHI-NING YANG, Shenzhen (CN); XIANG HE, Shenzhen (CN); HUA-DONG CHENG, Shenzhen (CN)

(21) Appl. No.: 13/734,926

(22) Filed: Jan. 5, 2013

(30) Foreign Application Priority Data
Sep. 27, 2012 (CN) 2012103654272

(51) Int. Cl. G06F 3/0488

(52) U.S. Cl. 715/798

(57) ABSTRACT

An apparatus capable of switching displayed pictures in response to a slide gesture by a user includes a display screen for displaying a zoomed in current picture, a touch determining unit, a picture processing unit, a control unit, a time calculating unit, and a calculating unit. The picture processing unit determines a width value of the current picture and a distance between a side of the current picture and an edge of the display screen adjacent to the side. The control unit controls the display screen to only display the target picture if a ratio of the distance to the width is equal to or greater than a predetermined ratio, and controls the display screen to only redisplay the current picture if a time duration of a slide gesture from beginning to ending is smaller than a predetermined time period. A related method is also provided.

### BACKGROUND

1. Technical Field

The present disclosure relates to pictures changing technology and, particularly, to an apparatus and a method capable of switching displayed pictures in response to slide gestures.

2. Description of the Related Art

Mobile terminals are usually employed to display pictures. A user can drag a picture displayed on a touch display screen of the mobile terminal to a direction to change the picture to a target picture. However, if the user drags the displayed picture too quickly, more pictures than the user wants have been changed, in which condition the user has to drag the displayed picture to an opposite direction to return to the target picture, which is inconvenient for the user. Therefore, there is room for improvement within the art.

### BRIEF DESCRIPTION OF THE DRAWING

The components in the drawings are not necessarily drawn to scale, the emphasis instead being placed icon clearly illustrating the principles of the disclosure. Moreover, in the drawing, like reference numerals designate corresponding parts throughout the several views.

FIG. 1 is a diagram block of an apparatus capable of switching displayed pictures in response to slide gestures, according to an exemplary embodiment.

FIG. 2 is a schematic diagram showing a state of use of displaying a current picture zoomed in on the apparatus of FIG. 1, in accordance with an exemplary embodiment.

FIG. 3 is a schematic diagram showing a state of use of dragging the current picture displayed on the apparatus of FIG. 1, in accordance with an exemplary embodiment.

FIG. 4 is a flowchart of a method capable of switching displayed pictures in response to slide gestures, in accordance with an exemplary embodiment.

### DETAILED DESCRIPTION

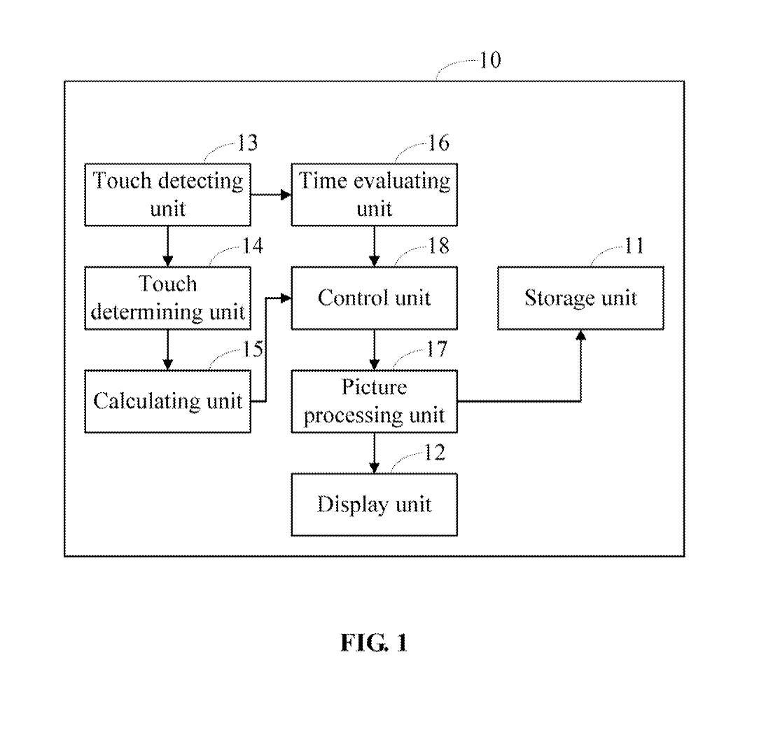

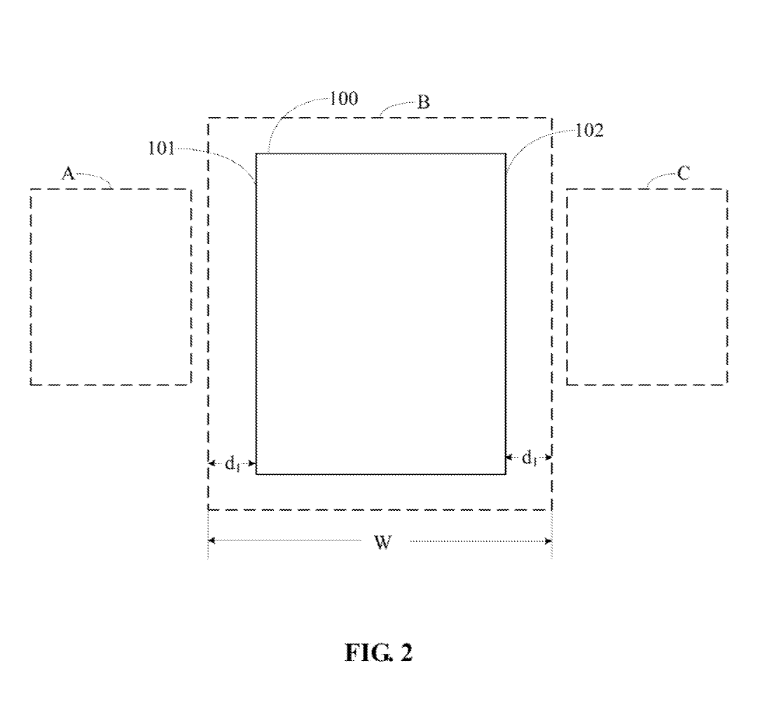

FIGS. 1 and 2 show an apparatus 10 of the embodiment. The apparatus 10 is capable of switching displayed pictures in response to slide gestures. The apparatus 10 includes a storage unit 11, a display screen 12, a touch detecting unit 13, a touch determining unit 14, a calculating unit 15, a time calculating time 16, a picture processing unit 17, and a control unit 18. The display screen 12 is a touch display screen.

The storage unit 11 is configured for storing a plurality of pictures. The control unit 18 is configured for controlling the display screen 12 to display the plurality of pictures in a predetermined arrangement in a window 100 provided by the display screen 12. When one of the plurality of pictures displayed is touched by a finger of a user to be zoomed in, the control unit 18 controls the display screen 12 to display only the current picture in the window 100. The size of the current picture labeled with capital B shown in FIG. 2 is larger than the size of the window 100, which results in portion of the current picture B out of the window 100. The distance d₁ between the right side of the current picture B and a first edge 101 of the window 100 is equal to the distance d₁ between the left side of the current picture B and a second edge 102 of the window 100.

The touch detecting unit 13 is configured for detecting a slide gesture by the user on the display screen 12, and further determining a sliding direction of the detected slide gesture. The touch determining unit 14 is configured for selecting a target picture from the pictures according to the determined sliding direction. In detail, the touch determining unit 14 determines the target picture to be a picture before the current picture when the sliding direction is left to right or up to down. The touch determining unit 14 determines the target picture to be a picture next the current picture when the sliding direction is right to left or down to up. The picture processing unit 17 is configured for controlling moving the current picture on the display screen 12 along the sliding direction toward a first edge 101 of the display screen 12 in response to the slide gesture such that a portion thereof adjacent to the first edge is moved out of the display screen 12, and controlling moving a portion of the target picture into the display screen 12 from an opposite second edge 102 thereof along the sliding direction in response to the slide gesture.

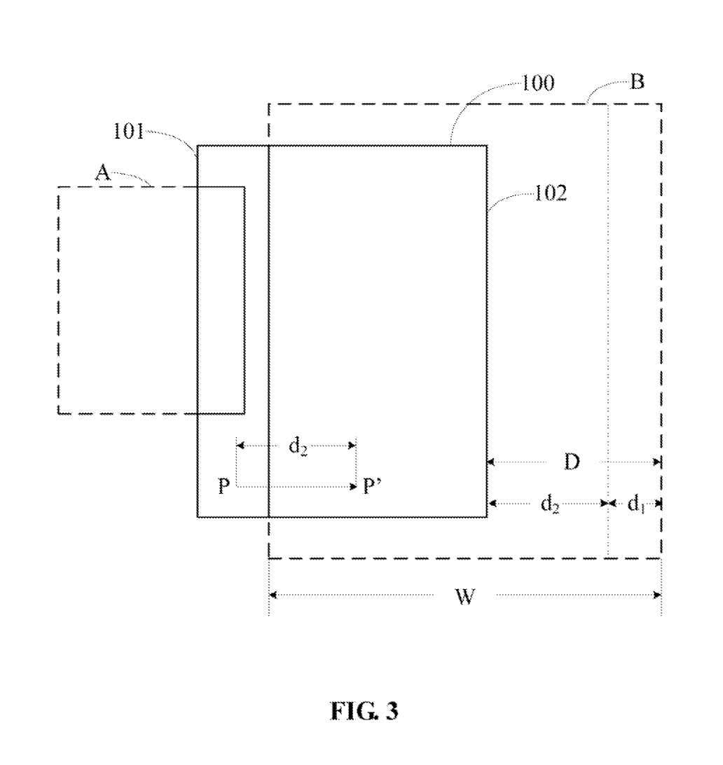

FIG. 3, shows that when the touch detecting unit 13 does not further detect any touch position after a predetermined time period elapses, the touch determining unit 14 determines a distance d₂ between a touch beginning position P and a touch ending position P′ of a trace of the detected slide gesture. The picture processing unit 17 obtains a width value W of the current picture B, and determines a distance D between the edge of the display screen 12 which the sliding direction towards and a side of the current picture parallel with and adjacent to the edge prior to performing the slide gesture by the user. The calculating unit 15 is configured for calculating a ratio S of the distance D to the width value W.

The control unit 18 determines whether the ratio S calculated is equal to or greater than a predetermined ratio. In the embodiment, the predetermined ratio is 1/2. When the ratio S is equal to or greater than the predetermined ratio, the control unit 18 generates a first picture obtaining signal. The picture processing unit 17 obtains the target picture in response to the first picture obtaining signal, and controls the display screen 12 to only display the obtained target picture.

For example, when the target picture is the picture labeled with capital A before the current picture B, the picture processing unit 17 determines the distance D by adding the distance d₁ to the distance d₂. The calculating unit 15 calculates the ratio S between the distance D and the width value W, namely, (d₁+d₂)/W. The control unit 18 determines the ratio S calculated is equal to or greater than the predetermined ratio.

When the ratio S is smaller than the predetermined ratio, the control unit 18 remains displaying the current picture B on the window 100.

When the display screen 12 displays the obtained target picture, the time calculating unit 16 is configured for calculating a time duration T of the slide gesture from the touch beginning position P to the touch ending touch position P′. The control unit 18 determines whether the time duration T calculated is smaller than a predetermined time period.

When the time duration T is smaller than the predetermined time period, the control unit 18 generates a second picture obtaining signal. The picture processing unit 17 obtains the current picture B in response to the second picture obtaining signal, and controls the display screen 12 to redisplay only the current picture (as shown in FIG. 2).

When the time duration T calculated is equal to or greater than the predetermined time period, the control unit 18 remains displaying the target picture on the window 100.

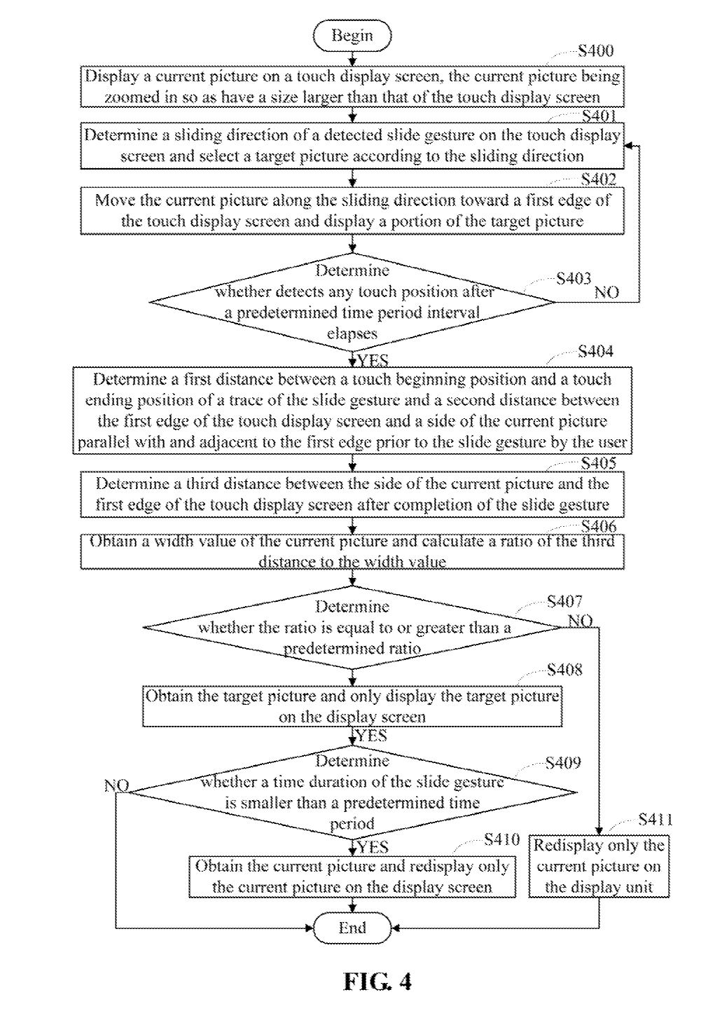

Referring to FIG. 4, a method capable of switching displayed pictures in response to slide gestures.

In step S400, the control unit 18 controls the display screen 12 to display the current picture on the display screen 12, the current picture being zoomed in so as to have a size larger than the size of the display screen 12, which results in portion of the current picture out of the display screen 12.

In step S401, the touch detecting unit 13 detects a slide gesture by a user on the display screen 12, and determines a sliding direction of the detected slide gesture. The touch determining unit 14 selects a target picture according to the determined sliding direction.

In detail, the touch determining unit 14 selects the target picture to be a picture before the current picture when the sliding direction is left to right or up to down. The touch determining unit 14 selects the target picture to be a picture next the current picture when the sliding direction is right to left or down to up.

In step S402, the picture processing unit 17 controls moving the current picture on the display screen 12 along the sliding direction toward a first edge 101 of the display screen 12 in response to the slide gesture, and displays a portion of the target picture on the display screen 12 in response to the slide gesture.

In step S403, the touch detecting unit 13 determines whether further detects any touch position after a predetermined time period interval elapses, if yes, the procedure goes to step S404, otherwise, the procedure returns to step S401.

In step S404, the touch determining unit 14 determines the distance d₂ between a touch beginning position P and a touch ending position P′ of a trace of the slide gesture. The picture processing unit 17 determines the distance d₁ between the first edge 101 of the display screen 12 and a side of the current picture B parallel with and adjacent to the first edge prior to the slide gesture by the user.

The distance d₁ between the right side of the current picture B and the first edge 101 of the window 100 is equal to the distance d₁ between the left side of the current picture B and the second edge 102 of the window 100.

In step S405, the picture processing unit 17 obtains the width value W of the current picture B, and determines a distance D between the side of the current picture and the first edge of the display screen 12 after completion of the slide gesture.

In step S406, the calculating unit 15 calculates the ratio S of the distance D to the width value W.

In step S407, the control unit 18 determines whether the ratio S calculated is equal to or greater than a predetermined ratio. If yes, the procedure goes to step S408, otherwise, the procedure goes to step S411.

In step S408, the control unit 18 generates the first picture obtaining signal, the picture processing unit 17 obtains the target picture in response to the first picture obtaining signal, and controls the display screen 12 to only display the obtained target picture.

In step S409, the time calculating time 16 calculates a time duration T of the slide gesture from the touch beginning position P to the touch ending position P′. The control unit 18 determines whether the time duration T calculated is smaller than a predetermined time period, if yes, the procedure goes to step S410, otherwise, the procedure ends.

In step S410, the control unit 18 generates the second picture obtaining signal. The picture processing unit 17 obtains the current picture in response to the second picture obtaining signal, and controls the display screen 12 to redisplay only the current picture. Then, the procedure ends.

In step S411, the control unit 18 remains displaying the current picture on the displaying unit 12. Then, the procedure ends.

It is understood that the present disclosure may be embodied in other forms without departing from the spirit thereof. Thus, the present examples and embodiments are to be considered in all respects as illustrative and not restrictive, and the disclosure is not to be limited to the details given herein.

What is claimed is:

1. An apparatus capable of switching displayed pictures in response to a slide gesture by a user, comprising:
a storage unit configured for storing a plurality of pictures;
a display screen configured for displaying a current picture in response to a user's touch, wherein the current picture is zoomed in and has a size larger than the size of the display screen;
a touch detecting unit configured for detecting a slide gesture by the user on the display screen, and further determining a sliding direction of the detected slide gesture;
a touch determining unit configured for selecting a target picture from the pictures according to the determined sliding direction; and further determining a first distance between a touch beginning position and a touch ending position of a trace of the detected slide gesture;
a picture processing unit configured for controlling moving the current picture on the display screen along the sliding direction toward a first edge of the display screen in response to the slide gesture such that a portion thereof adjacent to the first edge is moved out of the display screen, and controlling moving a portion of the target picture into the display screen from an opposite second edge thereof along the sliding direction in response to the slide gesture; the picture processing unit further configured for obtaining a width value of the current picture, determining a second distance between the first edge of the display screen and a side of the current picture parallel with and adjacent to the first edge prior to the slide gesture by the user, and further determining a third distance between the first edge of the display screen and the side of the current picture after completion of the slide gesture;
a calculating unit configured for calculating a ratio of the third distance to the width value;
a time calculating unit configured for calculating a time duration of the slide gesture from the touch beginning position to the touch ending position; and
a control unit configured for generating a first picture obtaining signal if the ratio calculated is equal to or greater than the predetermined ratio for controlling the picture processing unit to obtain the target picture and controlling the display screen to only display the obtained target picture, the control unit configured for generating a second picture obtaining signal if the time duration is smaller than the predetermined time period for controlling the picture processing unit to obtain the current picture and controlling the display screen to redisplay only the current picture.

2. The apparatus capable of switching displayed pictures in response to a slide gesture by a user as claimed in claim 1, wherein the predetermined ratio is 1/2.

3. A method capable of switching displayed pictures in response to a slide gesture by a user, comprising:
displaying a current picture on a touch display screen, the current picture being zoomed in so as to have a size larger than the size of the touch display screen;
detecting a slide gesture by a user on the touch display screen, determining a sliding direction of the detected slide gesture, and further selecting a target picture according to the determined sliding direction;
controlling the current picture to move along the sliding direction toward a first edge of the touch display screen, and displaying a portion of the target picture on the touch display screen in response to the slide gesture;
determining a first distance between a touch beginning position and a touch ending position of a trace of the detected slide gesture, and a second distance between the first edge of the touch display screen and a side of the current picture parallel with and adjacent to the first edge prior to the slide gesture by the user;
determining a third distance between the side of the current picture and the first edge of the touch display screen after completion of the slide gesture;
obtaining a width value of the current picture and calculating a ratio of the third distance to the width value;
determining whether the ratio calculated is equal to or greater than a predetermined ratio;
generating a first picture obtaining signal if the ratio calculated is equal to or greater than the predetermined ratio for obtaining the target picture and only displaying the obtained target picture on the touch display screen;
calculating a time duration of the slide gesture from the touch beginning position to the touch ending position, and determining whether the time duration is smaller than a predetermined time period; and
generating a second picture obtaining signal if the time duration is smaller than a predetermined time period for obtaining the current picture and redisplaying only the current picture on the touch display screen.

4. The method as claimed in claim 3, wherein when the ratio calculated is smaller than the predetermined ratio value, the method further comprises: redisplaying only the current picture on the touch display screen.

5. The method as claimed in claim 3, wherein the predetermined ratio is 1/2.

6. The method as claimed in claim 3, wherein if the time duration is equal to or greater than the predetermined time period, the method further comprises:
redisplaying only the target picture on the touch display screen.
